(19) United States
(12) Patent Application Publication
(10) Pub. No.: US 2024/0198958 A1
(43) Pub. Date: Jun. 20, 2024

(54) INFORMATION PROCESSING METHOD

(71) Applicant: TOYOTA JIDOSHA KABUSHIKI KAISHA, Toyota-shi (JP)

(72) Inventors: Hiroki TAKEISHI, Tokyo (JP); Koki MORIYA, Nagakute-shi (JP); Ibuki SHIMADA, Miyoshi-shi (JP); Koji UEDA, Funabashi-shi (JP); Ai MIYATA, Osaka (JP)

(73) Assignee: TOYOTA JIDOSHA KABUSHIKI KAISHA, Toyota-shi (JP)

(21) Appl. No.: 18/489,380

(22) Filed: Oct. 18, 2023

(30) Foreign Application Priority Data
Dec. 16, 2022 (JP) 2022-201595

(51) Int. Cl. B60R 25/24; B60R 25/01; G06Q 20/10; G06Q 50/30

(52) U.S. Cl. CPC B60R 25/24; B60R 25/01; G06Q 20/102; G06Q 50/30; B60R 2325/20

(57) ABSTRACT

The information processing method according to the information processing device includes: determining that an electronic key having authority with respect to a vehicle of the user is in a usable state; if it is determined that a payment for requesting work in the vehicle has been approved by the user, executing a settlement process; and notifying the operator terminal of permission to depart to the position of the vehicle after the completion of the settlement process.

### CROSS-REFERENCE TO RELATED APPLICATION

This application claims priority to Japanese Patent Application No. 2022-201595 filed on Dec. 16, 2022, incorporated herein by reference in its entirety.

### BACKGROUND

### 1. Technical Field

The present disclosure relates to an information processing method.

### 2. Description of Related Art

Hitherto, there is known a service in which a power supply vehicle rushes to a target vehicle and supplies electric power to the target vehicle when a power supply request to the target vehicle is made on an application (see, for example, NIO LIMITED, “NIO Power”, [online], 2022, [Searched on Dec. 14, 2022], Internet <URL: https://www.nio.com/nio-power>).

In recent vehicles, there are cases where a power supply port of the vehicle cannot be accessed unless an operator who will perform power supply opens the door of the power supply port with a key. If the background art is to be used, the driver needs to be present at the time of power supply. Therefore, there is a related art in which the door of the power supply port is opened by sharing a digital key with the operator. However, the sharing of the digital key or the opening and closing of the door may fail. It is desirable to avoid the generation of cost alone without being able to open the door of the power supply port.

### SUMMARY

In view of such circumstances, an object of the present disclosure is to securely provide a service by an operator.

An information processing method according to one embodiment of the present disclosure is an information processing method to be performed by an information processing device. The information processing method includes: determining whether an electronic key having authority on a vehicle of a user is ready for use; executing a settlement process when determination is made that the user has approved settlement for requesting an operation in the vehicle; and notifying an operator terminal about permission to depart to a position of the vehicle after completion of the settlement process.

According to the embodiment of the present disclosure, it is possible to securely provide the service by the operator.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic diagram of an information processing system;

FIG. 2 is a block diagram illustrating a configuration of an information processing device;

FIG. 3 is a block diagram illustrating a configuration of a user terminal;

FIG. 4 is a block diagram illustrating a configuration of an operator terminal;

FIG. 5 is a diagram illustrating user vehicles; and

FIG. 6 is a flowchart illustrating an operation of the information processing device.

### DETAILED DESCRIPTION OF EMBODIMENTS

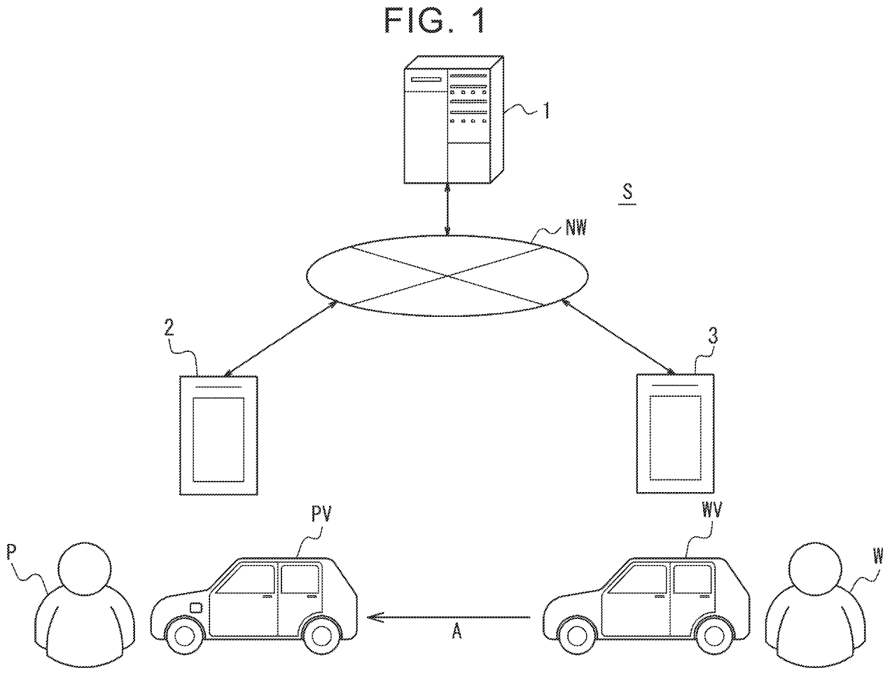

FIG. 1 is a schematic diagram of an information processing system S according to the present embodiment. The information processing system S includes an information processing device 1, a user terminal 2, and an operator terminal 3 that can communicate with each other via a network NW. The network NW includes, for example, a mobile communication network, a fixed communication network, or the Internet.

User terminal 2 is operated by user P. The user P drives the user vehicle PV or rides on the user vehicle PV. The operator terminal 3 is operated by the operator W. The operator W drives the worker vehicle WV or rides on the worker vehicle WV. The worker vehicle WV moves to the position of the user vehicle PV as in the direction A in response to a power supply request from the user P. This movement is referred to as, for example, running. The worker vehicle WV supplies power from the worker vehicle WV to the user vehicle PV.

In FIG. 1, the information processing device 1, the user terminal 2, and the operator terminal 3 are illustrated one by one for convenience of explanation. However, the number of the information processing device 1, the user terminal 2, and the operator terminal 3 is not limited to this. For example, the processes executed by the information processing device 1 according to the present embodiment may be executed by a plurality of the information processing devices 1 disposed in a distributed manner.

The information processing device 1 is installed in facilities such as a data center. The information processing device 1 is, for example, a computer such as a server belonging to a cloud computing system or other computing systems.

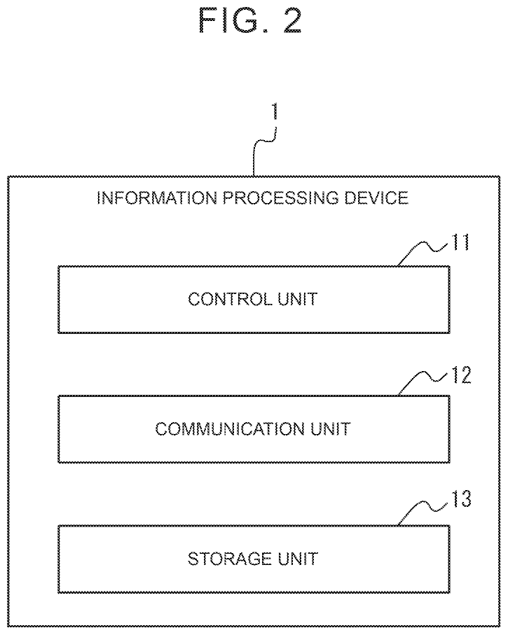

In FIG. 2, the internal configuration of the information processing device 1 will be described in detail.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including Central Processing Unit (CPU) or Micro Processing Unit (MPU). The control unit 11 may include one or more dedicated processors specialized for a specific process. The control unit 11 may include one or more dedicated circuits instead of including the processor. The dedicated circuitry may be, for example, Field-Programmable Gate Array (FPGA) or Application Specific Integrated Circuit (ASIC). The control unit 11 may include an Electronic Control Unit (ECU). The control unit 11 transmits and receives information via the communication unit 12.

The communication unit 12 includes a communication module corresponding to one or more wired or wireless Local Area Network (LAN) standards for connecting to a network NW. The communication unit 12 may include modules corresponding to one or more mobile communication standards including Long Term Evolution (LTE), Fourth Generation (4G), or Fifth Generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), Felica (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the present disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1.

The user terminal 2 is, for example, a mobile terminal such as a mobile phone, a smartphone, a wearable device, or a tablet. Alternatively, the user terminal 2 may be a general-purpose device such as a PC or a dedicated device. PC is an abbreviation for personal computer. User terminal 2 is operated by user P.

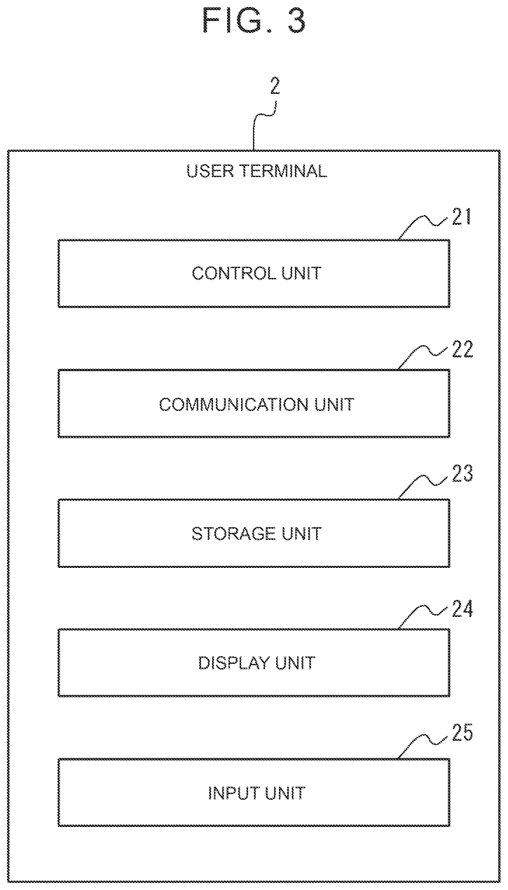

In FIG. 3, the internal configuration of the user terminal 2 will be described in detail.

The user terminal 2 includes a control unit 21, a communication unit 22, a storage unit 23, a display unit 24, and an input unit 25. Each component of the user terminal 2 is communicably connected to each other via, for example, a dedicated line.

The hardware configuration of the control unit 21, the communication unit 22, and the storage unit 23 of the user terminal 2 may be the same as the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. EL is an abbreviation for electro luminescence. Instead of being provided in the user terminal 2, the display unit 24 may be connected to the user terminal 2 as an external output device. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrally provided with a display, or a microphone. The input unit 25 receives an operation of inputting information used for the operation of the user terminal 2. Instead of being provided in the user terminal 2, the input unit 25 may be connected to the user terminal 2 as an external input device. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

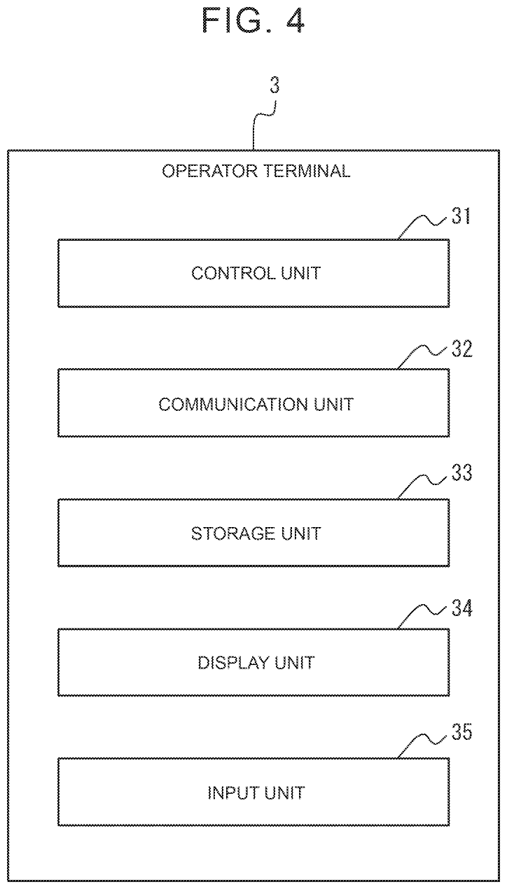

In FIG. 4, the internal configuration of the operator terminal 3 will be described in detail. The operator terminal 3 includes a control unit 31, a communication unit 32, a storage unit 33, a display unit 34, and an input unit 35. The constituent elements of the operator terminal 3 are communicably connected to each other via, for example, a dedicated line.

The hardware configuration of the control unit 31, the communication unit 32, the storage unit 33, the display unit 34, and the input unit 35 of the operator terminal 3 may be the same as the hardware configuration of the control unit 21, the communication unit 22, the storage unit 23, the display unit 24, and the input unit 25 of the user terminal 2. The description here is omitted.

Hereinafter, an information processing method by the information processing system S will be described in detail. Here, a scene in which the user P requests an operation (i.e., a service) of the user P on the vehicle PV will be described. The vehicle PV of the user P is also referred to as a user vehicle PV in order to distinguish it from the worker vehicle WV. Here, the user-vehicle PV is a battery electric vehicle, but the present disclosure is not limited thereto. Working on the user vehicle PV includes powering the user vehicle PV. Alternatively, the operation in the user vehicle PV may be in-vehicle cleaning of the user vehicle PV.

The user terminal 2 transmits a power supply request to the user-vehicle PV to the information processing device 1.

The control unit 11 of the information processing device 1 determines that an electronic key (that is, a digital key) having authority regarding the user-vehicle PV of the user P is available. This determination is performed by at least one of verifying the vehicle data of the user vehicle PV, causing the user P to open and close the door of the user vehicle PV, and remotely operating the user vehicle PV from a call center or the like. The electronic key is stored in the user terminal 2.

The authority regarding the user vehicle PV includes an authority to open and close the door of the user vehicle PV, and here includes an authority to open and close the door of the power supply port of the user vehicle PV. Alternatively, the authorization for the user vehicle PV may include the authorization to open and close the user vehicle PV trunks.

The control unit 11 determines whether or not a payment for requesting an operation in the user-vehicle PV has been approved by the user P. For example, the control unit 11 may request the user P to approve the payment via the user terminal 2. As an alternative, the control unit 11 may cause the user P to approve in advance that the payment is to be executed before the operator W leaves when the key is confirmed.

The control unit 11 executes the settlement process when it is determined that the settlement for requesting the operation on the user-vehicle PV has been approved by the user P.

After the completion of the settlement process, the control unit 11 notifies the operator terminal 3 of permission to depart to the position of the user-vehicle PV. The position of the user vehicle PV may be determined from the position data of the user vehicle PV or may be designated by the user P. The operator W rides on the worker vehicle WV and moves to the position of the user vehicle PV.

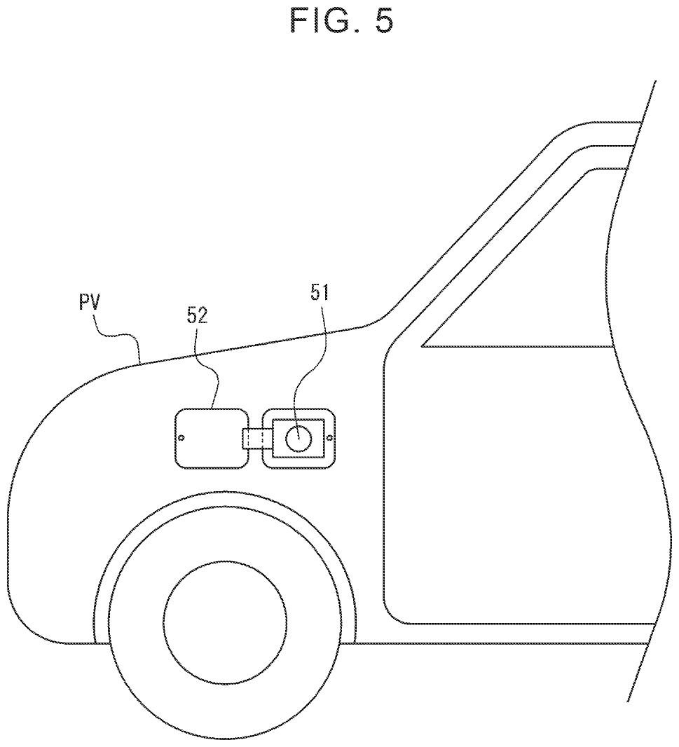

As shown in FIG. 5, the user-vehicle PV includes a power supply port 51 and a door 52 of the power supply port 51. The door 52 is opened and closed using an electronic key stored in the user terminal 2. When the worker vehicle WV arrives at the position of the user vehicle PV, the user vehicle PV receives power from the worker vehicle WV via the power supply port 51.

As an alternative, the control unit 11 may confirm that the electronic key is stored in the operator terminal 3, and then notify the operator terminal 3 of permission to depart to the position of the user-vehicle PV. In this case, the operator W opens and closes the door 52 using the electronic key stored in the operator terminal 3, and supplies power from the operator terminal 3 to the user-vehicle PV.

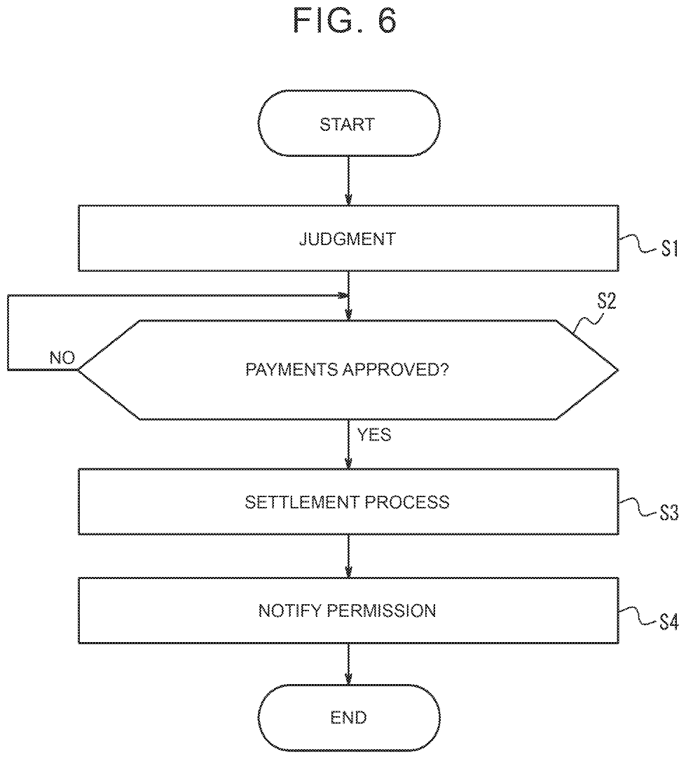

In FIG. 6, an information processing method by the control unit 11 of the information processing device 1 will be described.

In S1, the control unit 11 determines that an electronic key having an authority related to the user-vehicle PV is available. In S2, the control unit 11 determines whether or not a payment for requesting a task in the user-vehicle PV has been approved by the user P.

When S2 is Yes, the control unit 11 executes a settlement process in S3. The control unit 11 executes S2 again when No is performed by S2.

In S4, the control unit 11 notifies the operator terminal 3 of permission to depart to the position of the user-vehicle PV.

As described above, according to the present embodiment, the control unit 11 of the information processing device 1 executes an operation including: determining that an electronic key having authority related to the user vehicle PV is available; if it is determined that the payment for requesting the work on the user vehicle PV has been approved by the user P, executing the settlement processing; and notifying the operator terminal 3 of permission to depart to the position of the user vehicle PV after the completion of the settlement processing. With this configuration, the information processing device 1 can confirm that the electronic key is in a usable state before the start of the work, and thus can reliably provide the service by the operator W.

Further, according to the present embodiment, the operation of the control unit 11 includes confirming that the electronic key is stored in the operator terminal 3. With this configuration, the information processing device 1 enables the operator W to use the electronic key, so that the service can be provided more reliably.

Further, according to the present embodiment, the authority related to the user vehicle PV includes an authority to open and close the door of the user vehicle PV. The user vehicle PV is a battery electric vehicle. The authority regarding the user vehicle PV includes an authority to open and close the power supply port of the user vehicle PV. Working on the user vehicle PV includes powering the user vehicle PV. With this configuration, the information processing device 1 can confirm in advance that the operator W can open and close the power supply port at the site, and thus can reliably provide the service.

Further, according to the present embodiment, the operation of the control unit 11 includes determining that the electronic key is usable by at least one of verifying the vehicle data of the user vehicle PV, causing the user P to open and close the door of the user vehicle PV, and remotely operating the user vehicle PV. With this configuration, the information processing device 1 can more reliably determine that the electronic key is in a usable state.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions and the like included in each means or each step can be rearranged so as not to logically contradict each other. Multiple means or steps may be combined or divided into one.

For example, in the above embodiment, a program that executes all or part of the functions or processes of the information processing device 1 can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a Digital Versatile Disc (DVD) or a Compact Disc Read Only Memory (CD-ROM) in which the program is recorded. Further, the distribution of the program may be performed by storing the program in a storage of a server and transmitting the program from the server to another computer. Further, the program may be provided as a program product. The present disclosure can also be realized as a program that can be executed by a processor.

What is claimed is:

1. An information processing method to be performed by an information processing device, the information processing method comprising:
determining whether an electronic key having authority on a vehicle of a user is ready for use;
executing a settlement process when determination is made that the user has approved settlement for an operation in the vehicle; and
notifying an operator terminal about permission to depart to a position of the vehicle after completion of the settlement process.

2. The information processing method according to claim 1, further comprising checking whether the electronic key is stored in the operator terminal.

3. The information processing method according to claim 1, wherein the authority on the vehicle includes authority to open and close a door of the vehicle.

4. The information processing method according to claim 3, wherein:
the vehicle is a battery electric vehicle;
the authority on the vehicle includes authority to open and close a door of a power supply port of the vehicle; and
the operation in the vehicle includes power supply to the vehicle.

5. The information processing method according to claim 1, further comprising determining whether the electronic key is ready for use by at least one of verifying vehicle data of the vehicle, prompting the user to open and close a door of the vehicle, and remotely operating the vehicle.
